(19) United States
(12) Patent Application Publication
(10) Pub. No.: US 2026/0106476 A1
(43) Pub. Date: Apr. 16, 2026

(54) BATTERY CHARGING SYSTEM

(71) Applicant: Henry Investment Group LLC, Flower Mound, TX (US)

(72) Inventors: James David Henry, Flower Mound, TX (US); Austin James Meyers, Plano, TX (US)

(73) Assignee: Henry Investment Group LLC, Flower Mound, TX (US)

(21) Appl. No.: 19/115,788

(22) PCT Filed: Sep. 27, 2023
(86) PCT No.: PCT/US2023/033900

§ 371 Date: Mar. 27, 2025

Related U.S. Application Data
(60) Provisional application No. 63/410,284, filed on Sep. 27, 2022.

(51) Int. Cl. H02J 7/70; H02J 7/00

(52) U.S. Cl. CPC H02J 7/751; H02J 7/485; H02J 7/50; H02J 2207/20

(57) ABSTRACT

A battery charging system includes a power distribution system configured to be electrically coupled to a power source, at least one voltage booster circuit electrically coupled, to the power distribution system and configured to increase voltage received from the power distribution system, and a plurality of charger systems, each charger system of the plurality of charger systems coupled to a voltage booster circuit of the at least one voltage booster circuits.

### CROSS-REFERENCE TO RELATED APPLICATIONS

This patent application claims priority from, and incorporates by reference the entire disclosure of, U.S. Provisional Application No. 63/410,284 filed on Sep. 27, 2022.

### TECHNICAL FIELD

The present application relates generally to battery charging systems and more particularly, but not by way of limitation, to a mobile battery charging system.

### BACKGROUND

This section provides background information to facilitate a better understanding of the various aspects of the disclosure. It should be understood that the statements in this section of this document are to be read in this light, and not as admission of prior art.

Rechargeable battery packs are becoming more and more prevalent as their performance capabilities have been increasing. In some instances, environmental and/or noise regulations forbid the use of gas-powered devices. For example, in some counties the use of gas-powered tools and equipment is being phased out in favor of electricity-powered devices. While rechargeable battery packs have improved greatly in recent years, they still offer a limited amount of operating time before becoming depleted. In a commercial setting (e.g., commercial landscaping, construction, etc.), there is a need to keep multiple rechargeable battery packs on hand. However, there are practical limitations to the number of rechargeable battery packs that may be transported with a user. It would be beneficial to have a compact, customizable, and universal battery charging system to provide increased operating time.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, a battery charging system includes a power distribution system configured to be electrically coupled to a power source, at least one voltage booster circuit electrically coupled to the power distribution system and configured to increase voltage received from the power distribution system; and a plurality of charger systems, each charger system of the plurality of charger systems coupled to a voltage booster circuit of the at least one voltage booster circuits.

In some aspects, the power distribution system comprises a plurality of voltage outputs. In some aspects, each voltage output is electrically coupled to its own voltage booster circuit. In some aspects, each voltage output is eclectically coupled to the same voltage booster circuit.

In some aspects, each charger system of the plurality charger systems includes a removable charging adapter.

In some aspects, the battery charging system further includes a plurality of removable charging adaptors, the plurality of removable charging adaptors comprising at least one removable charging adapter having a first connector type configured to connect to a first type of rechargeable battery and at least one removable charging adapter having a second connector type configured to connect to a second type of rechargeable battery.

In some aspects, the power distribution system is configured to be electrically coupled to one of a car battery, a wall outlet, an outlet of a generator, or an outlet of an electric vehicle charger.

In some aspects, the battery charging system further includes a tray that includes a plurality of compartments, each compartment of the plurality of compartments configured to receive a rechargeable battery and to house the power distribution system and the at least one voltage booster circuit.

In some aspects, the plurality of charger systems are configured to charge one type of rechargeable battery. In some aspects, the plurality of charger systems are configured to charge at least two different types of rechargeable batteries.

In some aspects, a method of making a rechargeable battery system includes providing a power distribution system configured to be electrically coupled to a power source; eclectically coupling at least one voltage booster circuit to the power distribution system, the at least one voltage booster circuit being configured to increase voltage received from the power distribution system; and electrically coupling a plurality of charger systems to the at least one voltage booster circuit.

### DESCRIPTION OF THE DRAWINGS

A more complete understanding of the subject matter of the present disclosure may be obtained by reference to the following Detailed Description when taken in conjunction with the accompanying Drawings wherein:

FIG. 1 is a schematic diagram of a battery charging system according to aspects of the disclosure;

FIG. 2 is a schematic diagram of a power distribution system according to aspects of the disclosure;

FIG. 3 is a circuit diagram for a voltage boost circuit according to aspects of the disclosure;

FIG. 4 is a schematic diagram illustrating a battery charger for a battery pack according to aspects of the disclosure; and

FIG. 5 is a schematic diagram illustrating a voltage boost board according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

The instant disclosure relates to a battery charging system that uses a readily available power source (e.g., a vehicle battery or, in some aspects, a power outlet from a wall, generator, electric vehicle charge station, or the like) to charge one or more rechargeable battery packs. The battery charging system controls the current and voltage that each rechargeable battery receives to maintain safe charging parameters so that each battery is charged to its ideal voltage. In some aspects, the battery charging system includes a built-in control to prevent the power source's battery (e.g., the battery of a vehicle in which the battery charging system is installed) from falling below a certain voltage value (e.g., a value that would prevent the vehicle from be able to start).

In some aspects, the battery charging system includes a plurality of charge connectors, each of which may be connected to a rechargeable battery. In some aspects, the plurality of charge connectors are configured to be compatible with a single type of battery connector (i.e., for a specific brand of rechargeable battery). In some aspects, the plurality of charge connectors are configured to be adaptable to a variety of battery connectors (i.e., for a variety of brands and battery types). For example, the system may include a variety of removable adapters that permit a variety of rechargeable battery packs to be connected to the battery charging system.

In some aspects, the battery charging system includes a battery tray in which one or more rechargeable batteries are placed while charging. The tray may include a plurality of receptacles or compartments into which the rechargeable batteries are placed while being charged/transported. The receptacles may be padded or include straps/tie downs to help secure the rechargeable batteries in place. In some aspects, the tray may be a drawer that slides into and out of a housing. The housing may be secured within a vehicle (e.g., truck, van, etc.).

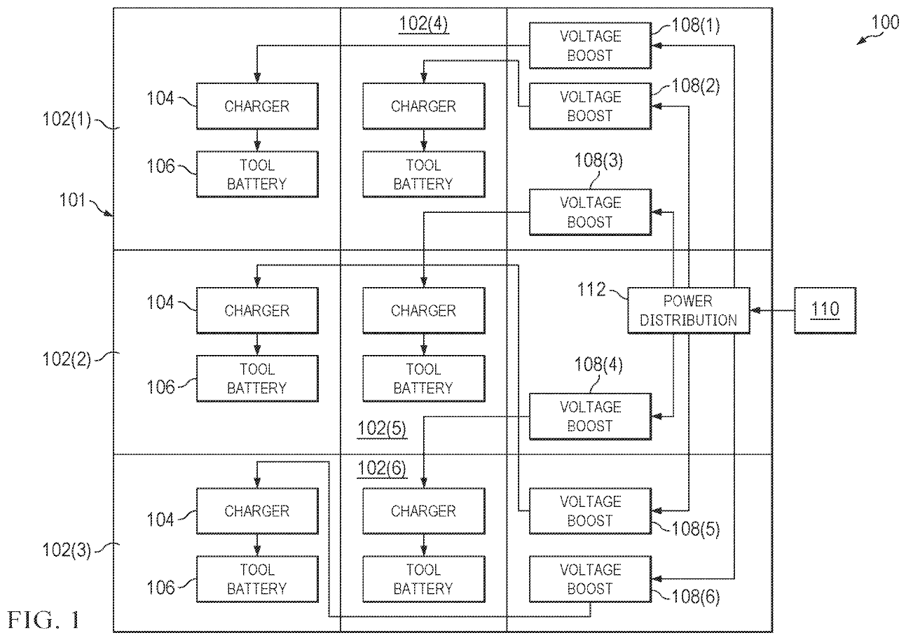

FIG. 1 is a schematic diagram of a battery charging system 100, according to aspects of the disclosure. Battery charging system 100 includes a tray 101 that includes compartments 102(1)-(6), with each compartment accommodating a battery charger 104 and a rechargeable battery 106. FIG. 1 illustrates how power may be distributed from a battery 110 (e.g., a car battery) to a plurality of rechargeable batteries 106. Given the voltage input of a car's battery, a power distribution system 112 allocates the same voltage to several voltage booster circuits 108(1)-(6). In the example shown in FIG. 1, battery charging system 100 is configured to charge up to six rechargeable batteries 106 at the same time. Six rechargeable batteries 106 are shown for illustrative purposes, it will be appreciated by those having skill in the art that battery charging system 100 may be modified to accommodate more or fewer rechargeable batteries 106. In some aspects, battery charger system 100 is configured to charge six identical rechargeable batteries. In these aspects, compartments 102(1)-(6) may be identical in shape and size. In some aspects, battery charging system 100 is configured to charge two or more different types (e.g., different sizes, brands, models, or the like) of rechargeable batteries. In these aspects, compartments 102(1)-(6) may comprise a plurality of shapes and sizes to accommodate different sizes and shapes of rechargeable batteries.

Power is provided in this example by battery 110. In other aspects, the power could be provided from an outlet (e.g., a wall outlet, a power generator, an electric vehicle charger, etc.). Each of the six rechargeable batteries 106 is attached to a power circuit that includes battery 110, power distribution block 112, one voltage booster 108, and a charger 104. Power distribution block 112 splits the power from battery 110 into six circuits, one for each rechargeable battery 106. As shown in FIG. 1, six voltage boosters 108(1)-(6) are connected to power distribution block 112. In other aspects, a single voltage booster 108 may be used, with each of the six rechargeable batteries 106 connected thereto. Voltage booster 108 converts the input voltage into a higher output voltage. For example, input voltage from a standard car battery is around 12-15 V. In one aspect, voltage booster 108 is configured to output around 20 V. In other aspects, voltage booster 108 may be configured to output different voltages depending upon the needs of the rechargeable batteries 106.

Each battery charger 104 is connected to one voltage booster 108 (i.e., six chargers for six rechargeable batteries in the example shown in FIG. 1). In some aspects, each battery charger 104 is fitted with a removable adapter configured to attach to a specific connector type for a rechargeable battery. In some aspects, each charger includes a hard-wired connector that is specific to a particular rechargeable battery (i.e., the battery charging system may be made to work exclusively with a single manufacturer's connector). To charge a rechargeable battery 106, the rechargeable batten. 106 is connected to one of the battery chargers 104.

FIG. 2 is a circuit diagram illustrating power distribution system 112, according to aspects of the disclosure. Voltage from battery 110 is fed into power distribution system 112. Power distribution system 112 includes a plurality of voltage outputs 116, each of which is configured to provide the same output voltage as the input voltage. Each voltage output 116 is connected to one voltage booster 108. Each individual voltage output 116 is connected to a fuse 114 that will trip if the current through the respective output exceeds the fuse's rating. This ensures that power distribution system 112 will not supply unsafe levels of current into the system along any output branch in the case of a malfunction.

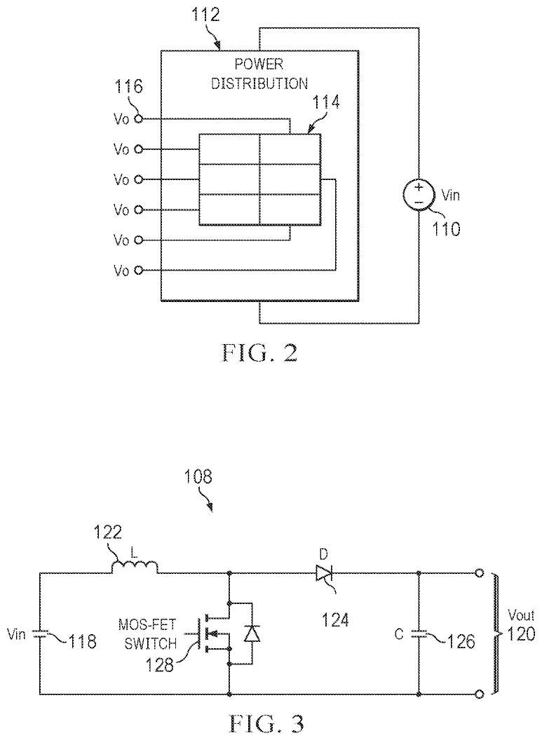

FIG. 3 is a circuit diagram of one voltage booster 108, according to aspects of the disclosure. Voltage booster 108 converts an input voltage (e.g., 12-15V) into a higher output voltage (e.g., 20V). Power is fed to voltage booster 108 via Vᵢₙ 118 (i.e., from voltage output 116 of power distribution system 112). The circuit includes an inductor 122, a diode 124, a capacitor 126, and a MOSFET switch 128. Voltage is output from voltage booster 108 at Vₒᵤₜ 120. Voltage boosters are well known devices, and can be tuned to provide a desired output voltage by selecting appropriate inductors, diodes, capacitors, and MOSFET switches.

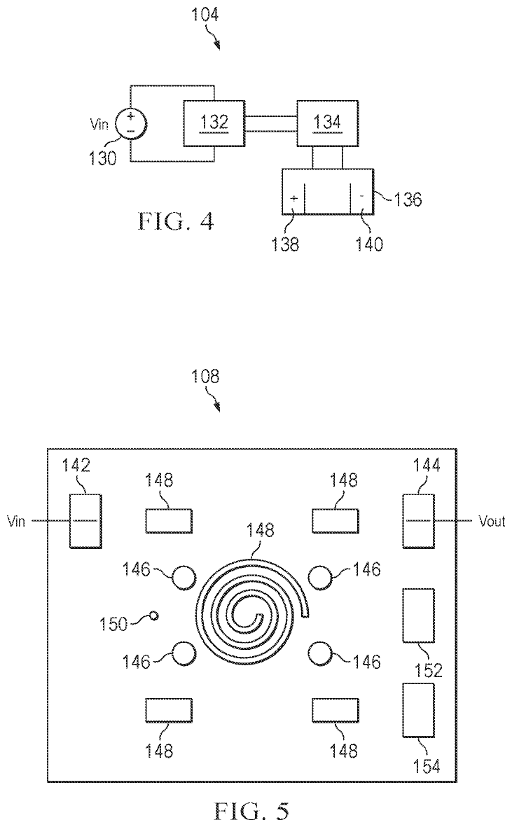

FIG. 4 is a circuit diagram of battery charger 104, according to aspects of the disclosure. Each battery charger 104 supplies power to one rechargeable battery 106. Battery charger 104 includes a charge adapter 134 with a positive terminal 138 and negative terminal 140 that is housed in a connector 136. Connector 136 is configured to receive a particular battery type (e.g., band/model of battery). In some aspects, charge adapter 134 is removable so that a variety of adapters can be plugged into battery charger 104 to accommodate different battery types. Plug 132 allows battery charger 104 itself to be removed from battery charging system 100. Power is introduced to battery charger 104 at V. 130 (i.e., from Vₒᵤₜ 120).

FIG. 5 is a schematic diagram of an alternate design of a voltage booster, according to aspects of the disclosure. The voltage booster of FIG. 5 may be implemented as voltage booster 108. As per the schematic diagram, the voltage booster for FIG. 5 includes an inductor 147, a plurality of capacitors 146, a plurality of heat sinks 148, and a safety fuse 150 to prevent current overdraw. Voltage boost board 109 contains both a port for input voltage as well as a port for output voltage. Present also are two adjustable systems 152, 154 that allow for control of the output voltage and output current of the board, respectively.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A battery charging system comprising:
a power distribution system configured to be electrically coupled to a power source;
at least one voltage booster circuit electrically coupled to the power distribution system and configured to increase voltage received from the power distribution system; and
a plurality of charger systems, each charger system of the plurality of charger systems coupled to a voltage booster circuit of the at least one voltage booster circuits.

2. The system of claim 1, wherein the power distribution system comprises a plurality of voltage outputs.

4. The system of claim 2, wherein each voltage output is electrically coupled to its own voltage booster circuit.

5. The system of claim 2, wherein each voltage output is electrically coupled to the same voltage booster circuit.

6. The system of claim 1, wherein each charger system of the plurality charger systems includes a removable charging adapter.

7. The system of claim 1, further comprising a plurality of removable charging adaptors, the plurality of removable charging adaptors comprising at least one removable charging adapter having a first connector type configured to connect to a first type of rechargeable battery and at least one removable charging adapter having a second connector type configured to connect to a second type of rechargeable battery.

8. The system of claim 1, wherein the power distribution system is configured to be electrically coupled to one of a car battery, a wall outlet, an outlet of a generator, or an outlet of an electric vehicle charger.

9. The system of claim 1, further comprising a tray that includes a plurality of compartments, each compartment of the plurality of compartments configured to receive a rechargeable battery and to house the power distribution system and the at least one voltage booster circuit.

10. The system of claim 1, wherein the plurality of charger systems are configured to charge one type of rechargeable battery.

11. The system of claim 1, wherein the plurality of charger systems are configured to charge at least two different types of rechargeable batteries.

12. A method of making a rechargeable battery system, the method comprising:
providing a power distribution system configured to be electrically coupled to a power source;
electrically coupling at least one voltage booster circuit to the power distribution system, the at least one voltage booster circuit being configured to increase voltage received from the power distribution system; and
electrically coupling a plurality of charger systems to the at least one voltage booster circuit.

13. The method of claim 12, wherein the power distribution system comprises a plurality of voltage outputs.

14. The method of claim 13, wherein each voltage output is electrically coupled to its own voltage booster circuit.

15. The method of claim 13, wherein each voltage output is electrically coupled to the same voltage booster circuit.

16. The method of claim 12, wherein each charger system of the plurality charger systems includes a removable charging adapter.

17. The method of claim 12, further comprising a plurality of removable charging adaptors, the plurality of removable charging adaptors comprising at least one removable charging adapter having a first connector type configured to connect to a first type of rechargeable battery and at least one removable charging adapter having a second connector type configured to connect to a second type of rechargeable battery.

18. The method of claim 12, wherein the power distribution system is configured to be electrically coupled to one of a car battery, a wall outlet, an outlet of a generator, or an outlet of an electric vehicle charger.

19. The system of claim 1, wherein the plurality of charger systems are configured to charge one type of rechargeable battery.

20. The system of claim 1, wherein the plurality of charger systems are configured to charge at least two different types of rechargeable batteries.
